(19) United States
(12) Patent Application Publication
(10) Pub. No.: US 2002/0145057 A1
(43) Pub. Date: Oct. 10, 2002

(54) Fertilizer mixing device for sprinkler systems

(76) Inventors: Charles Thomas Leedy, Rancho Palos Verdes, CA (US); Mary Lou Leedy, Rancho Palos Verdes, CA (US)

Correspondence Address: Richard W. Goldstein, 2071 Clove Road, Staten Island, NY, 10304, US

(21) Appl. No.: 09/829,270

(22) Filed: Apr. 9, 2001

(51) Int. Cl. B05B 7/26

(52) U.S. Cl. 239/310

(57) ABSTRACT

A fertilizer mixing device for sprinkler systems including a water inlet pipe having a water inlet, a first water outlet, and a second water outlet. The water inlet is in communication with an existing water source. A mixing chamber is adapted for holding a predetermined amount of fertilizer and water therein. The mixing chamber comprises a housing having a first opening therein for receiving the first water outlet of the water inlet pipe therein. The housing has a check valve disposed therein. The check valve includes an input pipe and an output pipe. A water outlet pipe is provided that has a first water inlet, a second water inlet, and a water outlet. The first water inlet is in communication with the second water outlet of the water inlet pipe. The second water inlet pipe is in communication with the output pipe of the check valve of the mixing chamber. The water outlet is connectable with an existing sprinkler system.

### BACKGROUND OF THE INVENTION

The present invention relates to a fertilizer mixing device for sprinkler systems and more particularly pertains to allowing fertilizer to be distributed through a sprinkler system.

The use of fertilizer dispensing systems is known in the prior art. More specifically, fertilizer dispensing systems heretofore devised and utilized for the purpose of dispensing fertilizer are known to consist basically of familiar, expected and obvious structural configurations, notwithstanding the myriad of designs encompassed by the crowded prior art which have been developed for the fulfillment of countless objectives and requirements.

By way of example, U.S. Pat. No. 3,833,177 to Pasley discloses a fluid disseminating device with means for automatic mixing and gradual discharge of an additive, such as a nutrient, for application to a lawn or garden. U.S. Pat. No. 5,022,585 to Burgess and 5,775,593 to Delorme disclose various automatic fertilizing and irrigating systems. U.S. Pat. No. 4,333,493 to Beiswenger discloses a plant fertilizer system attachable to a supply hose.

While these devices fulfill their respective, particular objective and requirements, the aforementioned patents do not describe a fertilizer mixing device for sprinkler systems for allowing fertilizer to be distributed through a sprinkler system.

In this respect, the fertilizer mixing device for sprinkler systems according to the present invention substantially departs from the conventional concepts and designs of the prior art, and in doing so provides an apparatus primarily developed for the purpose of allowing fertilizer to be distributed through a sprinkler system.

Therefore, it can be appreciated that there exists a continuing need for a new and improved fertilizer mixing device for sprinkler systems which can be used for allowing fertilizer to be distributed through a sprinkler system. In this regard, the present invention substantially fulfills this need.

### SUMMARY OF THE INVENTION

In the view of the foregoing disadvantages inherent in the known types of fertilizer dispensing systems now present in the prior art, the present invention provides an improved fertilizer mixing device for sprinkler systems. As such, the general purpose of the present invention, which will be described subsequently in greater detail, is to provide a new and improved fertilizer mixing device for sprinkler systems which has all the advantages of the prior art and none of the disadvantages.

To attain this, the present invention essentially comprises a water inlet pipe having a water inlet, a first water outlet, and a second water outlet. The water inlet is in communication with an existing water source. The second water outlet has an adjustable gate valve coupled thereto. A mixing chamber is adapted for holding a predetermined amount of fertilizer and water therein. The mixing chamber comprises a housing having an open upper end with a removable sealing cap disposed thereon. The housing has a first opening therein for receiving the first water outlet of the water inlet pipe therein. The housing has a check valve disposed therein. The check valve includes an input pipe and an output pipe. The housing includes a bleeder valve. A water outlet pipe is provided that has a first water inlet, a second water inlet, and a water outlet. The first water inlet is in communication with the adjustable gate valve of the second water outlet of the water inlet pipe. The second water inlet pipe is in communication with the output pipe of the check valve of the mixing chamber. The water outlet is connectable with an existing sprinkler system.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved fertilizer mixing device for sprinkler systems which has all the advantages of the prior art fertilizer dispensing systems and none of the disadvantages.

It is another object of the present invention to provide a new and improved fertilizer mixing device for sprinkler systems which may be easily and efficiently manufactured and marketed.

It is a further object of the present invention to provide a new and improved fertilizer mixing device for sprinkler systems which is of durable and reliable construction.

An even further object of the present invention is to provide a new and improved fertilizer mixing device for sprinkler systems which is susceptible of a low cost of manufacture with regard to both materials and labor, and which accordingly is then susceptible of low prices of sale to the consuming public, thereby making such a fertilizer mixing device for sprinkler systems economically available to the buying public.

Even still another object of the present invention is to provide a new and improved fertilizer mixing device for sprinkler systems for allowing fertilizer to be distributed through a sprinkler system.

Lastly, it is an object of the present invention to provide a new and improved fertilizer mixing device for sprinkler systems including a water inlet pipe having a water inlet, a first water outlet, and a second water outlet. The water inlet is in communication with an existing water source. A mixing chamber is adapted for holding a predetermined amount of fertilizer and water therein. The mixing chamber comprises a housing having a first opening therein for receiving the first water outlet of the water inlet pipe therein. The housing has a check valve disposed therein. The check valve includes an input pipe and an output pipe. A water outlet pipe is provided that has a first water inlet, a second water inlet, and a water outlet. The first water inlet is in communication with the second water outlet of the water inlet pipe. The second water inlet pipe is in communication with the output pipe of the check valve of the mixing chamber. The water outlet is connectable with an existing sprinkler system.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side view of the preferred embodiment of the fertilizer mixing device for sprinkler systems constructed in accordance with the principles of the present invention.

FIG. 2 is a cross-sectional view of the present invention illustrating the operation thereof.

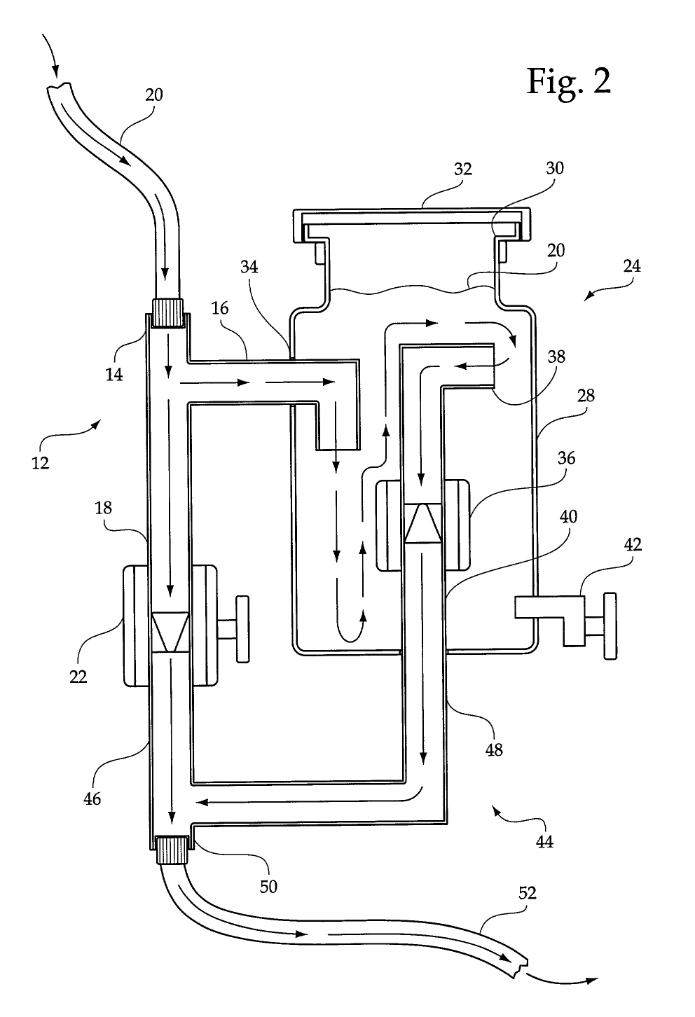

The same reference numerals refer to the same parts through the various figures.

### DESCRIPTION OF THE PREFERRED EMBODIMENT

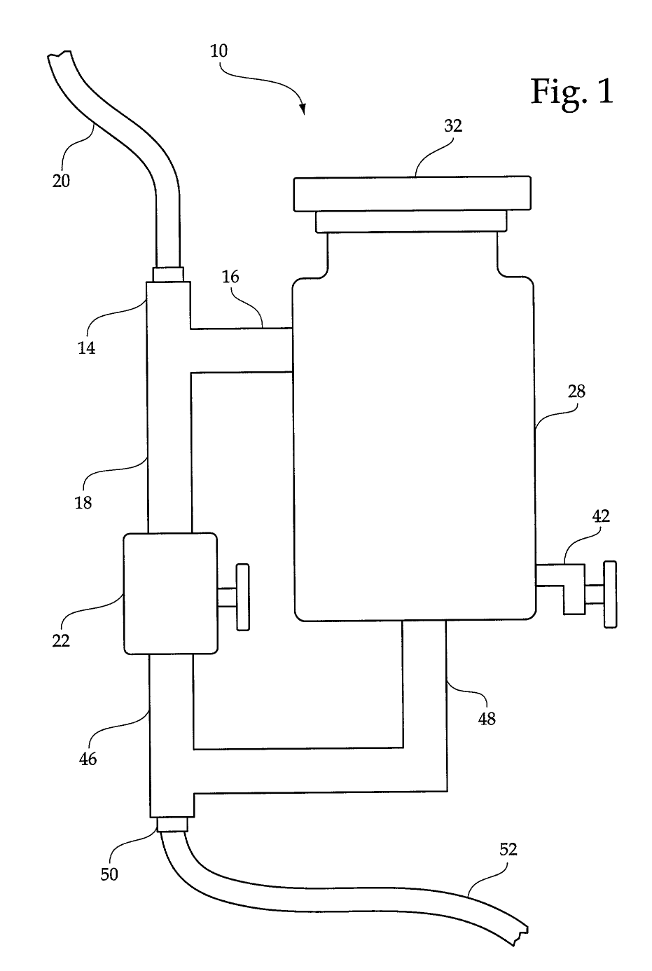

With reference now to the drawings, and in particular, to FIGS. 1 through two thereof, the preferred embodiment of the new and improved fertilizer mixing device for sprinkler systems embodying the principles and concepts of the present invention and generally designated by the reference number 10 will be described.

Specifically, it will be noted in the various Figures that the device relates to a fertilizer mixing device for sprinkler systems for allowing fertilizer to be distributed through a sprinkler system. In its broadest context, the device consists of a water inlet pipe, a mixing chamber, and a water outlet pipe. Such components are individually configured and correlated with respect to each other so as to attain the desired objective.

The water inlet pipe 12 has a water inlet 14, a first water outlet 16, and a second water outlet 18. The water inlet 14 is in communication with an existing water source 20. The second water outlet 18 has an adjustable gate valve 22 coupled thereto.

The mixing chamber 24 is adapted for holding a predetermined amount of fertilizer and water 26 therein. The mixing chamber 24 comprises a housing 28 having an open upper end 30 with a removable sealing cap 32 disposed thereon. The housing 28 has a first opening 34 therein for receiving the first water outlet 16 of the water inlet pipe 12 therein. The housing 28 has a check valve 36 disposed therein. The check valve 36 includes an input pipe 38 and an output pipe 40. The housing 28 includes a bleeder valve 42 to allow the housing 28 to be drained as needed.

The water outlet pipe 44 is provided that has a first water inlet 46, a second water inlet 48, and a water outlet 50. The first water inlet 46 is in communication with the adjustable gate valve 22 of the second water outlet 18 of the water inlet pipe 12. The second water inlet 48 is in communication with the output pipe 40 of the check valve 36 of the mixing chamber 24. The water outlet 50 is connectable with an existing sprinkler system 52.

To activate the system, the water source 20 must be turned on so that water will enter the water outlet pipe 12 through the water inlet 14. Some of the water will enter the housing 28 through the first water outlet 16 and the rest of the water will enter the gate valve 22 through the second water outlet 16. The water in the housing 28 will stop against the check valve 36 until enough pressure has built up whereupon water mixed with fertilizer will exit the housing 28 through the output pipe 40 into the water outlet pipe 44. This mixed water will again mix with the water from the gate valve 22. The gate valve 22 can be adjusted to control the amount of fertilizer that will exit the water outlet 50. The more water let through the gate valve 22, the more diluted the water/fertilizer mixture will become.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by letters patent of the united states is as follows:

1. A fertilizer mixing device for sprinkler systems for allowing fertilizer to be distributed through a sprinkler system comprising, in combination:
a water inlet pipe having a water inlet and a first water outlet and a second water outlet, the water inlet being in communication with an existing water source, the second water outlet having an adjustable gate valve coupled thereto;
a mixing chamber adapted for holding a predetermined amount of fertilizer and water therein, the mixing chamber comprising a housing having an open upper end with a removable sealing cap disposed thereon, the housing having a first opening therein for receiving the first water outlet of the water inlet pipe therein, the housing having a check valve disposed therein, the check valve including an input pipe and an output pipe, the housing including a bleeder valve; and
a water outlet pipe having a first water inlet, a second water inlet, and a water outlet, the first water inlet being in communication with the adjustable gate valve of the second water outlet of the water inlet pipe, the second water inlet pipe being in communication with the output pipe of the check valve of the mixing chamber, the water outlet being connectable with an existing sprinkler system.

2. A fertilizer mixing device for sprinkler systems for allowing fertilizer to be distributed through a sprinkler system comprising, in combination:
a water inlet pipe having a water inlet and a first water outlet and a second water outlet, the water inlet being in communication with an existing water source;
a mixing chamber adapted for holding a predetermined amount of fertilizer and water therein, the mixing chamber comprising a housing having a first opening therein for receiving the first water outlet of the water inlet pipe therein, the housing having a check valve disposed therein, the check valve including an input pipe and an output pipe; and
a water outlet pipe having a first water inlet, a second water inlet, and a water outlet, the first water inlet being in communication with the second water outlet of the water inlet pipe, the second water inlet pipe being in communication with the output pipe of the check valve of the mixing chamber, the water outlet being connectable with an existing sprinkler system.

3. The fertilizer mixing device for sprinkler systems as set forth in claim two, wherein the second water outlet of the water inlet pipe has an adjustable gate valve coupled thereto.

4. The fertilizer mixing device for sprinkler systems as set forth in claim two, wherein the housing has an open upper end with a removable sealing cap disposed thereon.

5. The fertilizer mixing device for sprinkler systems as set forth in claim two, wherein the housing includes a bleeder valve.
